(19) United States
(12) Patent Application Publication
(10) Pub. No.: US 2026/0002394 A1
(43) Pub. Date: Jan. 1, 2026

(54) VEHICLE HINGE ASSEMBLY INCLUDING DAMPER WITH FLUID AND HYDROPHOBIC MATERIAL

(71) Applicant: Ford Global Technologies, LLC, Dearborn, MI (US)

(72) Inventors: Mohammad Omar Faruque, Ann Arbor, MI (US); S.M. Iskander Farooq, Novi, MI (US)

(21) Appl. No.: 18/754,885

(22) Filed: Jun. 26, 2024

(51) Int. Cl. E05D 11/08; E05D 3/02; E05D 5/10

(52) U.S. Cl. CPC E05D 11/084; E05D 3/02; E05D 5/10; E05D 2005/106; E05Y 2900/546

(57) ABSTRACT

A hinge assembly may include a panel configured to open and close relative to an opening of the motor vehicle. A hinge assembly may include a hinge assembly configured to couple the panel to a body of the motor vehicle, wherein the hinge assembly includes a damper including a fluid and a hydrophobic material.

### TECHNICAL FIELD

This disclosure relates to a vehicle including a hinge assembly for a motor vehicle, and in particular to a hinge assembly for a rear closure assembly of the motor vehicle. The hinge assembly includes a damper including fluid and a hydrophobic material.

### BACKGROUND

Minivans, sport utility vehicles (SUVs), hatchbacks, and other vehicles have an opening defined in a rear portion of the vehicle's body. Ordinarily, these vehicles include liftgates that are used to selectively open and close the opening in the rear portion of the vehicle. Some liftgates are powered liftgates, which are opened and closed by an automated system. Other liftgates are manually opened and closed by a user.

### SUMMARY

In some aspects, the techniques described herein relate to an assembly for a motor vehicle, including: a panel configured to open and close relative to an opening of the motor vehicle; and a hinge assembly configured to couple the panel to a body of the motor vehicle, wherein the hinge assembly includes a damper including a fluid and a hydrophobic material.

In some aspects, the techniques described herein relate to an assembly, wherein: the damper includes a piston and a cylinder, the fluid and the hydrophobic material are within the cylinder, and movement of the panel results in movement of the piston relative to the cylinder.

In some aspects, the techniques described herein relate to an assembly, wherein movement of the panel from an open position to a closed position causes the piston to compress the contents of the cylinder.

In some aspects, the techniques described herein relate to an assembly, wherein: the hinge assembly includes a first bracket configured to couple to the body of the motor vehicle, and a second bracket configured to couple to the panel, and the first bracket is rotatably coupled to the second bracket.

In some aspects, the techniques described herein relate to an assembly, wherein: the hinge assembly includes a rack and a pinion, and the piston is mounted to an end of the rack.

In some aspects, the techniques described herein relate to an assembly, wherein: the hinge assembly includes a pin, the first bracket is coupled to the pin so as to permit rotation of the pin relative to the first bracket, and the second bracket is rigidly coupled to the pin such that rotation of the second bracket results in rotation of the pin.

In some aspects, the techniques described herein relate to an assembly, wherein the pinion is mounted to the pin.

In some aspects, the techniques described herein relate to an assembly, wherein: the pinion includes a first tab projecting from an opposite side of the rack as the pinion, and the hinge assembly includes a second tab configured to contact the first tab to prevent further relative rotation of the first and second brackets when the panel is in the open position.

In some aspects, the techniques described herein relate to an assembly, wherein the hydrophobic material includes a hydrophobic nanoporous material.

In some aspects, the techniques described herein relate to an assembly, wherein the damper is configured such that, when the panel is in a fully open position, the damper is able to resist movement of the panel toward the closed position.

In some aspects, the techniques described herein relate to an assembly, wherein the damper is configured such that the damper applies a substantially linearly-increasing resistance force over an entirety of a range of motion of the panel between an open position and a closed position.

In some aspects, the techniques described herein relate to an assembly, wherein the panel is a panel of a liftgate and the opening is a rear opening of the motor vehicle.

In some aspects, the techniques described herein relate to an assembly, wherein the hinge assembly is a first hinge assembly, and wherein a second hinge assembly spaced-apart from the first hinge assembly is configured to couple the panel to the body of the motor vehicle.

In some aspects, the techniques described herein relate to an assembly, wherein the second hinge assembly includes a damper including a fluid and a hydrophobic material.

In some aspects, the techniques described herein relate to a motor vehicle, including: a panel configured to open and close relative to an opening of the motor vehicle; and a hinge assembly configured to couple the panel to a body of the motor vehicle, wherein the hinge assembly includes a damper including a fluid and a hydrophobic material.

In some aspects, the techniques described herein relate to a motor vehicle, wherein the panel is a panel of a liftgate.

In some aspects, the techniques described herein relate to a motor vehicle, wherein: the damper includes a piston and a cylinder, the fluid and the hydrophobic material are within the cylinder, and movement of the panel from an open position to a closed position causes the piston to compress the contents of the cylinder.

In some aspects, the techniques described herein relate to a method, including: resisting movement of a panel using a damper of a hinge assembly, wherein the panel is moveable relative to an opening of a motor vehicle, and wherein the damper includes a fluid and a hydrophobic material.

In some aspects, the techniques described herein relate to a method, wherein resisting movement includes holding the panel in a fully open position.

In some aspects, the techniques described herein relate to a method, wherein resisting movement includes resisting movement of the panel from an open position to a closed position by applying a substantially linearly-increasing resistance force throughout an entirety of a range of motion of the panel.

### BRIEF DESCRIPTION OF THE DRAWINGS

FIG. 1 is a rear-perspective view of a portion of a motor vehicle including a rear closure assembly, which includes a liftgate. In FIG. 1, the liftgate is in a closed position.

FIG. 2 is a rear-perspective view of the portion of the motor vehicle with the liftgate in a fully open position.

FIG. 3 is a perspective view of a portion of a body of the motor vehicle and two hinge assemblies.

FIG. 4 is a perspective view of an example hinge assembly.

FIG. 5 is a view representative of an arrangement of a piston and a cylinder.

FIG. 6 is a perspective view of a portion of the example hinge assembly of FIG. 4, and in particular illustrates a position of a piston when the liftgate is in the closed position.

FIG. 7 is a perspective view of the same portion of the example hinge assembly as in FIG. 6, and in particular illustrates a position of the piston when the liftgate is in the fully open position.

FIG. 8 illustrates a portion of the example hinge assembly, including first and second tabs in contact with one another when the liftgate is in the fully open position.

FIG. 9 graphically represents an example relationship between resistance force of the damper and the position of the piston.

### DETAILED DESCRIPTION

This disclosure relates to a hinge assembly for a motor vehicle, and in particular to a hinge assembly for a rear closure assembly of the motor vehicle. The hinge assembly includes a damper including fluid and a hydrophobic material. Among other benefits, which will be appreciated from the below description, this disclosure is able to hold a liftgate in a fully open position and provides a relatively balanced resistance force when closing the liftgate. This disclosure also increases the ease of packaging relative to known designs.

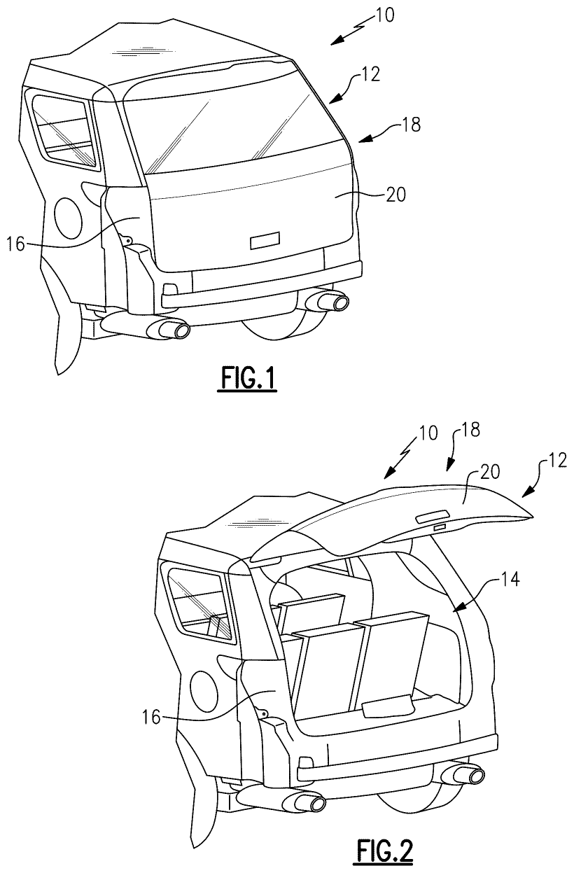

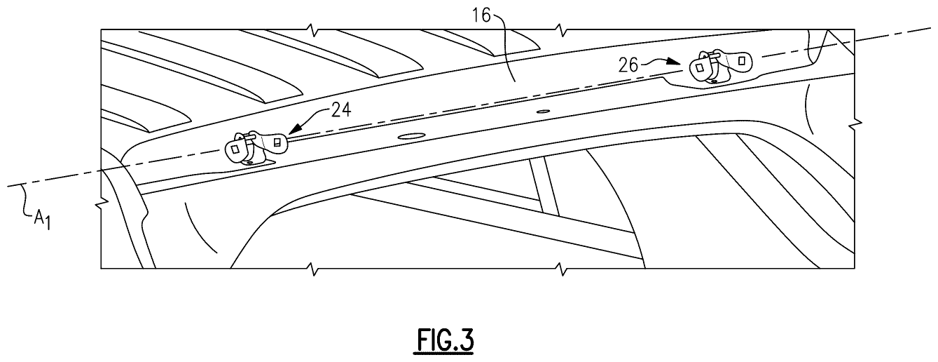

Referring to the drawings, FIG. 1 is a rear-perspective view of a portion of a motor vehicle 10 (“vehicle 10”), which is shown as a sport utility vehicle (SUV), including an example rear closure assembly 12 configured to selectively cover and uncover a rear opening 14 (FIG. 2) in the body 16 of the vehicle 10. While FIG. 1 shows an SUV, this disclosure is not limited to SUVs and extends to other types of vehicles, including minivans, hatchbacks, etc. Further, as used in this disclosure, the body 16 refers to the frame (including pillars) and paneling of the vehicle 10.

The rear closure assembly 12, in this disclosure, is a liftgate 18 and includes at least a liftgate panel 20 and, possibly, a window. The liftgate 18 is rotatably coupled to the body 17 via first and second hinge assemblies 24, 26 (FIG. 3). The hinge assemblies 24, 26 permit the liftgate 18 to rotate relative to the body 16 between the closed position of FIG. 1 and the fully open position of FIG. 2. Specifically, the liftgate 18 is rotatable about axis A1 between the closed position and the fully open position. Axis A1 is adjacent a top of the rear opening 14. While a liftgate is shown and described herein, this disclosure extends to hinge assemblies for other closure assemblies of a motor vehicle.

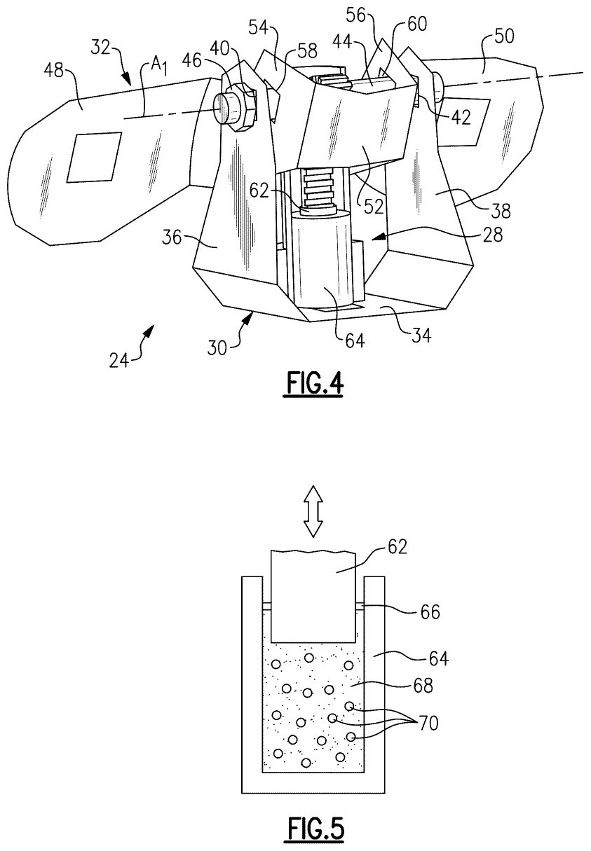

The hinge assembly 24 is shown in more detail in FIG. 4. In this example, the hinge assembly 24 includes a damper 28. The hinge assembly 26 could be configured substantially similar to the hinge assembly 24, or could alternatively exclude a damper. The hinge assemblies 24, 26 could be used together with a manually-operated liftgate 18 or a liftgate 18 that is able to open and close automatically or semi-automatically using a powered assembly (i.e., the liftgate 18 may be a powered liftgate).

The hinge assembly 24 includes a first bracket 30 configured to couple to the body 16, and a second bracket 32 configured to couple to the panel 20, either directly or via some other structure of the liftgate 18. The first bracket 30 includes a base 34 and first and second arms 36, 38 projecting from opposite sides of the base 34. The base 34 is configured to be fastened to the body 16. The first and second arms 36, 38 each include an opening 40, 42 receiving a pin 44. The pin 44 projects along axis A1. The pin 44 is configured to freely rotate relative to the first bracket 30. The pin 44 is held in place relative to the arms 36, 38 via projections 46 (only one visible in FIG. 4) adjacent ends of the pin 44. The first and second brackets 30, 32 are rotatably coupled to one another via the pin 44.

The second bracket 32 includes first and second ears 48, 50 configured to be fastened to the panel 20, either directly of via some other structure of the liftgate 18. Between the ears 48, 50, the second bracket 32 includes a central section 52 projecting from the ears 48, 50 into a space laterally between the arms 36, 38. The central section 52 is spaced-apart from the ears 48, 50 by arms 54, 56. Arms 54, 56 include openings 58, 60 receiving the pin 44. Adjacent the openings 58, 60, the arms 54, 56 are rigidly attached to the pin 44 such that rotation of the second bracket, and in turn the liftgate 18, results in rotation of the pin 44 about axis A1.

As noted, the hinge assembly 24 includes a damper 28. The damper 28 is an assembly including a piston 62 and a cylinder 64. The cylinder 64 is mounted to the base 34, and the piston 62 is slidable relative to the cylinder 64. The piston 62 and/or the cylinder 64 may include a seal 66 (FIG. 5) to resist fluid from exiting the cylinder 64.

In this example, the cylinder 64 is filled with a fluid 68 and a hydrophobic material 70. As will be discussed in more detail below, movement of the panel 20, and in particular the liftgate 18, from an open position toward the closed position causes the piston 62 to compress the contents of the cylinder 64, namely the fluid 68 and the hydrophobic material 70. The contents of the cylinder 64 resist compression by the piston 62.

In this disclosure, the fluid 68 may be water, ethylene glycol, or oil. The hydrophobic material 70 may be a nanoporous hydrophobic material, including pore sizes of 100 nm or smaller, in some examples. The hydrophobic material 70 may be a hydrophobic foam material in some examples. The hydrophobic material 70 can be interspersed within the fluid 68. The hydrophobic material 70 may be provided by metals, oxides, carbides, or carbon nanotubes, as examples. The hydrophobic material 70 may be porous and resist movement of the fluid 68 as the fluid 68 is compressed and forced to move through the pores. Specifically, the fluid 68 experiences resistance due to the narrow pathways of the pores and the surface tension effects. In turn, the contents of the cylinder 64 resist movement of the piston 62 into the cylinder 64.

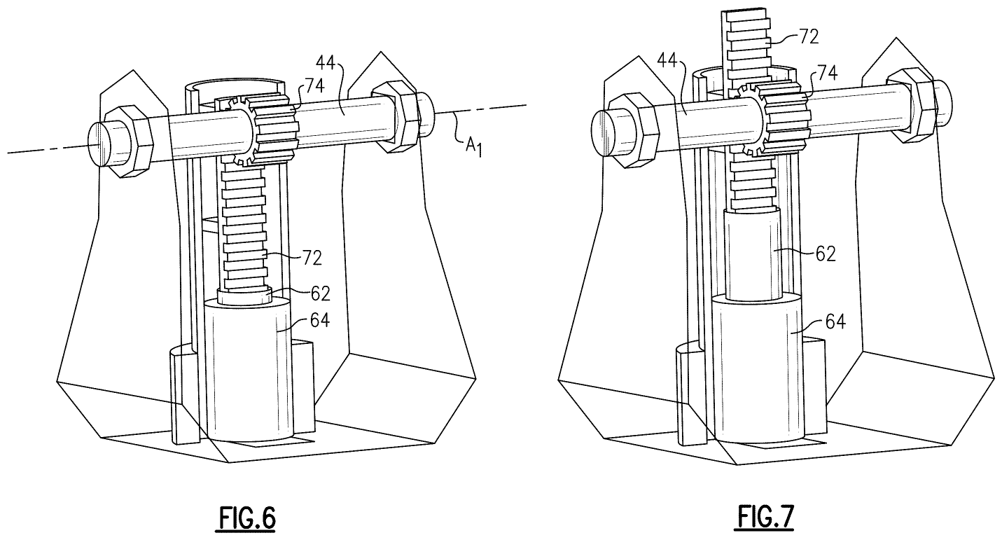

With reference to FIG. 6, rotation of the pin 44 is translated into movement of the piston 62 via a rack 72 and pinion 74 in this example. The pinion 74 is rigidly coupled to the pin 44 so as to rotate together with the pin 44 about axis A1. Rotation of the pinion 74 causes rack 72 to move vertically up and down, relative to the orientation of components in FIG. 6. The rack 72 is rigidly coupled to the piston 62 at an end of the rack 72. FIG. 6 illustrate the arrangement of the rack 72 and piston 62 with the liftgate 18 in a closed position, and FIG. 7 illustrates the arrangement of the rack 72 and piston with the liftgate 18 in the fully open position.

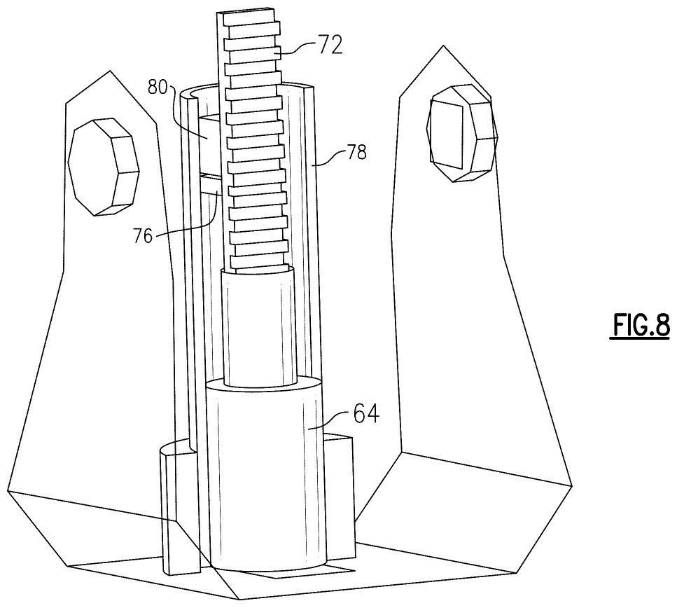

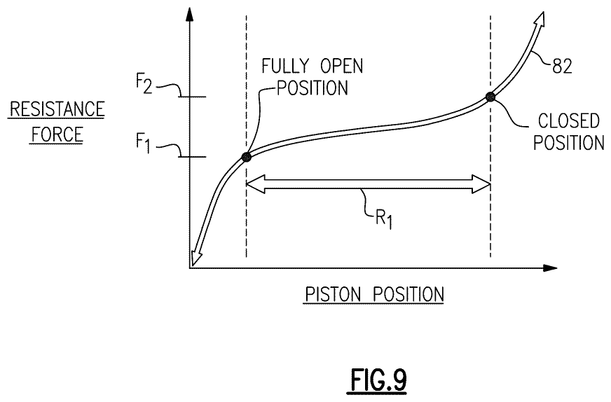

With reference to FIG. 8, in this example a first tab 76 projects from the rack 72 in a direction opposite the pinion 74. A housing 78 surrounding the cylinder 64 and rack 72 includes a second tab 80 projecting toward the rack 72. Contact between the first tab 76 and the second tab 80, as shown in FIG. 8, corresponds to a fully open position of the liftgate 18 and prevents further rotation of the liftgate 18 beyond the fully open position. In FIGS. 6-8 the first bracket 30 is semitransparent and the second bracket 32 is removed for ease of viewing.

The properties of the damper 28, including the size and shape of the cylinder 64 and the type of fluid 68 and hydrophobic material 70 selected, as well as a volume fraction of the fluid 68 and the hydrophobic material 70, is such that, when the liftgate 18 is in the fully open position, the damper 28 is able to resist movement of the panel toward the closed position. As represented in FIG. 9, the contents of the cylinder 64 exert a resistive force F1 on the piston 62, which prevents the liftgate 18 from closing under its own weight, for example, when the liftgate 18 is in the fully open position (or another open position, such as an intermediate position). Further, the damper 28 is configured such that contents of the cylinder 64 apply a substantially linearly-increasing resistance force over an entirety of a range of motion R1 of the liftgate 18 as the liftgate 18 moves between the fully open position and the closed position. As shown in FIG. 9, the force applied to the liftgate 18 to reach the closed position is substantially linear between F1 and F2, throughout range of motion R1. F2 is a resistance force of the contents of the cylinder 64 when the liftgate is in the closed position. As shown in FIG. 9, the curve 82 representing the resistance force applied by the damper 28 relative to a position of the piston 62 includes dramatically greater slopes to the left of the fully open position and to the right of the closed position, when compared to the slope of the curve 82 between the fully open and closed positions, which is substantially flatter and is substantially linearly-increasing. Various factors, including the size and shape of the cylinder 64 and the type of fluid 68 and hydrophobic material 70 selected, as well as a volume fraction of the fluid 68 and the hydrophobic material 70, is set so that those parts of the curve 82 exhibiting dramatically greater slopes are avoided during opening and closing the liftgate 18. For example, if the fully open position were moved to the left along the curve, the resistance force would drop and potentially not be able to hold the liftgate 18 in the fully open position. Further, if the closed position were moved to the right along the curve, the resistance force would increase and render it difficult for the liftgate 18 to reach the closed position. More generally, avoiding the dramatically greater slopes on the curve 82 provides a user with a sense of balance during operation of the liftgate 18.

It should be understood that terms such as “about,” “substantially,” and “generally” are not intended to be boundaryless terms, and should be interpreted consistent with the way one skilled in the art would interpret those terms. Further, terms such as “rearward,” “upper,” and “lower” are used herein for purposes of explanation only, and refer to the normal operational attitude of a vehicle.

Although the different examples have the specific components shown in the illustrations, embodiments of this disclosure are not limited to those particular combinations. It is possible to use some of the components or features from one of the examples in combination with features or components from another one of the examples. In addition, the various figures accompanying this disclosure are not necessarily to scale, and some features may be exaggerated or minimized to show certain details of a particular component or arrangement.

One of ordinary skill in this art would understand that the above-described embodiments are exemplary and non-limiting. That is, modifications of this disclosure would come within the scope of the claims. Accordingly, the following claims should be studied to determine their true scope and content.

1. An assembly for a motor vehicle, comprising:
a panel configured to open and close relative to an opening of the motor vehicle; and
a hinge assembly configured to couple the panel to a body of the motor vehicle, wherein the hinge assembly includes a damper including a fluid and a hydrophobic material.

2. The assembly as recited in claim 1, wherein:
the damper includes a piston and a cylinder,
the fluid and the hydrophobic material are within the cylinder, and
movement of the panel results in movement of the piston relative to the cylinder.

3. The assembly as recited in claim 2, wherein movement of the panel from an open position to a closed position causes the piston to compress the contents of the cylinder.

4. The assembly as recited in claim 2, wherein:
the hinge assembly includes a first bracket configured to couple to the body of the motor vehicle, and a second bracket configured to couple to the panel, and
the first bracket is rotatably coupled to the second bracket.

5. The assembly as recited in claim 4, wherein:
the hinge assembly includes a rack and a pinion, and
the piston is mounted to an end of the rack.

6. The assembly as recited in claim 5, wherein:
the hinge assembly includes a pin,
the first bracket is coupled to the pin so as to permit rotation of the pin relative to the first bracket, and
the second bracket is rigidly coupled to the pin such that rotation of the second bracket results in rotation of the pin.

7. The assembly as recited in claim 6, wherein the pinion is mounted to the pin.

8. The assembly as recited in claim 7, wherein:
the pinion includes a first tab projecting from an opposite side of the rack as the pinion, and
the hinge assembly includes a second tab configured to contact the first tab to prevent further relative rotation of the first and second brackets when the panel is in the open position.

9. The assembly as recited in claim 1, wherein the hydrophobic material includes a hydrophobic nanoporous material.

10. The assembly as recited in claim 1, wherein the damper is configured such that, when the panel is in a fully open position, the damper is able to resist movement of the panel toward the closed position.

11. The assembly as recited in claim 1, wherein the damper is configured such that the damper applies a substantially linearly-increasing resistance force over an entirety of a range of motion of the panel between an open position and a closed position.

12. The assembly as recited in claim 1, wherein the panel is a panel of a liftgate and the opening is a rear opening of the motor vehicle.

13. The assembly as recited in claim 1, wherein the hinge assembly is a first hinge assembly, and wherein a second hinge assembly spaced-apart from the first hinge assembly is configured to couple the panel to the body of the motor vehicle.

14. The assembly as recited in claim 13, wherein the second hinge assembly includes a damper including a fluid and a hydrophobic material.

15. A motor vehicle, comprising:
a panel configured to open and close relative to an opening of the motor vehicle; and
a hinge assembly configured to couple the panel to a body of the motor vehicle, wherein the hinge assembly includes a damper including a fluid and a hydrophobic material.

16. The motor vehicle as recited in claim 15, wherein the panel is a panel of a liftgate.

17. The motor vehicle as recited in claim 15, wherein:
the damper includes a piston and a cylinder,
the fluid and the hydrophobic material are within the cylinder, and
movement of the panel from an open position to a closed position causes the piston to compress the contents of the cylinder.

18. A method, comprising:
resisting movement of a panel using a damper of a hinge assembly, wherein the panel is moveable relative to an opening of a motor vehicle, and wherein the damper includes a fluid and a hydrophobic material.

19. The method as recited in claim 18, wherein resisting movement includes holding the panel in a fully open position.

20. The method as recited in claim 18, wherein resisting movement includes resisting movement of the panel from an open position to a closed position by applying a substantially linearly-increasing resistance force throughout an entirety of a range of motion of the panel.
